(19) United States
(12) Patent Application Publication
(10) Pub. No.: US 2014/0070929 A1
(43) Pub. Date: Mar. 13, 2014

(54) Key Fob with Alarm Notification

(71) Applicant: Russell B. Myers, Grants Pass, OR (US)

(72) Inventor: Russell B. Myers, Grants Pass, OR (US)

(21) Appl. No.: 13/612,544

(22) Filed: Sep. 12, 2012

(51) Int. Cl. B60R 25/10

(52) U.S. Cl. 340/426.18

(57) ABSTRACT

A key fob with alarm notification is disclosed herein. The key fob notifies a user when a vehicle's alarm system has been triggered. Notification can occur by way of a visual notification, such as flashing light; an audible notification, such as a speaker that emits an alarm tone; or by way of a vibrating notification that causes the key fob to vibrate when an alarm event has occurred. The key fob contains buttons that control features commonly found in vehicular alarm system. These buttons may include a lock/arm button, an unlock/disarm button, or a button controlling any other feature found in a vehicle's alarm system.

### CROSS-REFERENCES TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### SEQUENCE LISTING

Not Applicable

### BACKGROUND OF THE INVENTION

1. Field of the Invention

The present invention relates to motor vehicle remote entry systems, and more specifically, to a key fob for use with an automobile alarm system that is configured to notify a user of an alarm event.

2. Description of the Related Art

Many automobiles are now equipped with wireless remote entry systems. These systems provide users with the convenience of locking or unlocking their vehicles from a distance, without the need to physically manipulate a key into a lock. Most vehicles also possess an alarm system that secures the vehicle from theft when left unattended. Manufacturers have integrated the locking and unlocking features of the remote entry systems with the disarming and arming features of the vehicle's alarm system. Both the locking mechanism of a vehicle and its alarm system can be controlled by a user through a wireless control device commonly referred to as a key fob.

Key fobs are becoming increasingly sophisticated with numerous capabilities being included with each fob. Modern key fobs frequently allow a user to perform such functions as opening a vehicle's trunk, flashing a vehicle's headlights, and sounding the vehicle's alarm. Some vehicle manufacturers have implemented remote engine start and window roll-down features into their vehicle's key fob. A user need only press a certain button or combination of buttons to have their vehicle start or roll down one or more windows. All of these key fob features have been included into vehicle design in an effort to increase user convenience or safety. Quite often a potential purchaser will not purchase a particular make or model if it is lacking basic key fob functionality.

With the advent of compact communication equipment, such as “phone on a chip” devices, it has recently become possible to equip both key fobs and vehicles with the ability to communicate over long distances. Some automobile manufacturers are even configuring their vehicles for communication over traditional networks such as cellular and Wi-Fi systems. These networks provide communication coverage in most urban and residential areas.

Despite increases in automotive communication capabilities, key fobs in the prior art still tend to be one-way communication devices and are usually incapable of receiving feedback from a vehicle. This lack of two-way communication is detrimental if an alarm event has occurred to the vehicle requiring the user's attention. In particular, the prior art lacks the ability for a key fob to notify the user when a vehicle's alarm system has been activated. Having the ability to know when a vehicle's alarm system has been activated would greatly benefit users by allowing them to quickly notify authorities or check on the vehicle to determine if it is a false alarm. Furthermore, the duration of noise emitted during a false alarm could be reduced if the user is quickly able to determine if an alarm event has occurred, and disarm the system if the event was a false alarm. Reducing theft and unnecessary noise would greatly benefit vehicle owners and bystanders within hearing distance of the vehicles.

Unfortunately, no key fobs exist that are specifically designed to receive alarm event communications from a user's vehicle. This is especially problematic in urban environments where rates of vehicle theft are high and the noise from false alarms can affect many bystanders. The present invention addresses bi-directional alarm event communications not addressed in the related art. The present invention provides a key fob capable of receiving an alarm event notification from a user's vehicle, and alerting the user to the alarm event.

### BRIEF SUMMARY OF THE INVENTION

Embodiments are disclosed to provide a vehicular key fob with bi-directional communication capability. The key fob can be used to indicate an alarm event to a user for an automobile, a motorcycle, or any other vehicle equipped with an alarm system.

In a preferred embodiment of the present invention, the key fob may receive alarm event notifications from a vehicle by way of communications sent through a cellular network. This preferred embodiment may provide a wide area of coverage for users of the key fob as cellular infrastructure is well-established in many regions and communities. The key fob method of communication is not limited to particular cellular protocols, radio frequencies, or cellular systems. Many competing cellular protocols such as 3G, GSM, LTE, EDGE, CDMA, WCDMA, exist today with new cellular protocols emerging frequently. The key fob may be configured to operate with any or all of the aforementioned protocols, or with new protocols as they are implemented.

In another preferred embodiment of the present invention, the key fob may receive alarm event notifications from a vehicle by way of communications sent through a local area network (LAN). LAN communications may be sent from a vehicle to a key fob through Wi-Fi wireless signals. Wi-Fi is a popular technology that allows computer networks to exchange information over the air using radio waves. The key fob and the vehicle's alarm system may be configured as computer devices on a Wi-Fi network for the purposes of communicating alarm events to the key fob. Although Wi-Fi is currently one of the most common protocols for wireless LAN communications, the present invention may be used with any future protocols developed for wireless communications between computers in a LAN.

In yet another preferred embodiment of the present invention, the key fob may receive alarm event notifications from a vehicle by way of communications sent through a wide area network (WAN). A WAN is a telecommunication network that covers broad areas such as entire communities, cities, or regions. This embodiment of the present invention may use a TCP/IP packet-based protocol across a single or multiple computer networks, such as the internet, to deliver alarm event communications to a key fob. WAN communications for purposes of the present invention may include wireless signals, wired signals, or any combination thereof used to transmit alarm event notifications.

The preceding embodiments are intended to be exemplary in nature and are not intended to be limiting. It is possible that those skilled in the art will see further embodiments of the present invention. Other objects and advantages of the present invention will be more fully apparent from the following disclosure.

### BRIEF DESCRIPTION OF THE SEVERAL VIEWS OF THE DRAWING(S)

FIG. 1 is a flowchart for using an exemplary key fob with alarm notification as according to one embodiment of the present invention;

FIG. 2 is a schematic block diagram of an exemplary key fob with alarm notification as according to one embodiment of the present invention;

FIG. 3 is a front view of an exemplary key fob with a visual alarm notification feature as according to one embodiment of the present invention;

FIG. 4 is a front view of an exemplary key fob with an audible alarm notification feature as according to one embodiment of the present invention; and

FIG. 5 is an interior view of an exemplary key fob with a vibrating alarm notification feature as according to one embodiment of the present invention.

A further understanding of the present invention can be obtained by reference to preferred embodiments set forth in the illustrations of the accompanying drawings. Although the illustrated embodiments are merely exemplary for carrying out the present invention, both the organization and methods of operation of the invention, in general, together with further objectives and advantages thereof, may be more easily understood by reference to the drawings and the following description. The drawings are not intended to limit the scope of this invention, which is set forth with particularity in the claims as appended or as subsequently amended, but merely to clarify and exemplify the invention.

### DETAILED DESCRIPTION OF THE INVENTION

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. Furthermore, a particular feature, structure, or characteristic described herein in connection with one embodiment may be implemented within other embodiments without departing from the scope of the invention. In addition, it is to be understood that the location or arrangement of individual elements within each disclosed embodiment may be modified without departing from the scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

The word “exemplary” is used herein to mean “serving as an example, instance, or illustration.” Any embodiment described herein as “exemplary” is not necessarily to be construed as preferred or advantageous over other embodiments. Likewise, the terms “embodiment(s) of the invention”, “alternative embodiment(s)”, and “exemplary embodiment(s)” do not require that all embodiments of the method, system, and apparatus include the discussed feature, advantage or mode of operation. The following description of the preferred embodiment is merely exemplary in nature and is in no way intended to limit the invention, its application, or use.

In a manner described below, the data processing aspects of the present invention may be implemented, in part, by programs that are executed by a computer. The term “computer” as used herein includes any device that electronically executes one or more programs, such as personal computers (PCs), hand-held devices, multi-processor systems, microprocessor-based programmable consumer electronics, network PCs, minicomputers, mainframe computers, routers, gateways, hubs and the like. The term “program” as used herein includes applications, routines, objects, components, data structures and the like that perform particular tasks or implement particular abstract data types. The term “program” as used herein further may connote a single program application or module or multiple applications or program modules acting in concert. The data processing aspects of the invention also may be employed in distributed computing environments, where tasks are performed by remote processing devices that are linked through a communications network. In a distributed computing environment, programs may be located in both local and remote memory storage devices.

Referring now to the present invention, there is described an exemplary key fob with alarm notification. For the purpose of clarity, the terms “key fob with alarm notification”, “key fob”, “present invention”, and “invention” may be used interchangeably to refer to the afore-mentioned key fob with alarm notification.

Several preferred embodiments of a key fob with alarm notification are discussed in this section. However, the invention is not limited to these embodiments. The present invention includes any key fob that notifies a user of an alarm event. The key fobs are not limited in method of notification, size, shape, or method of communication with the alarm system.

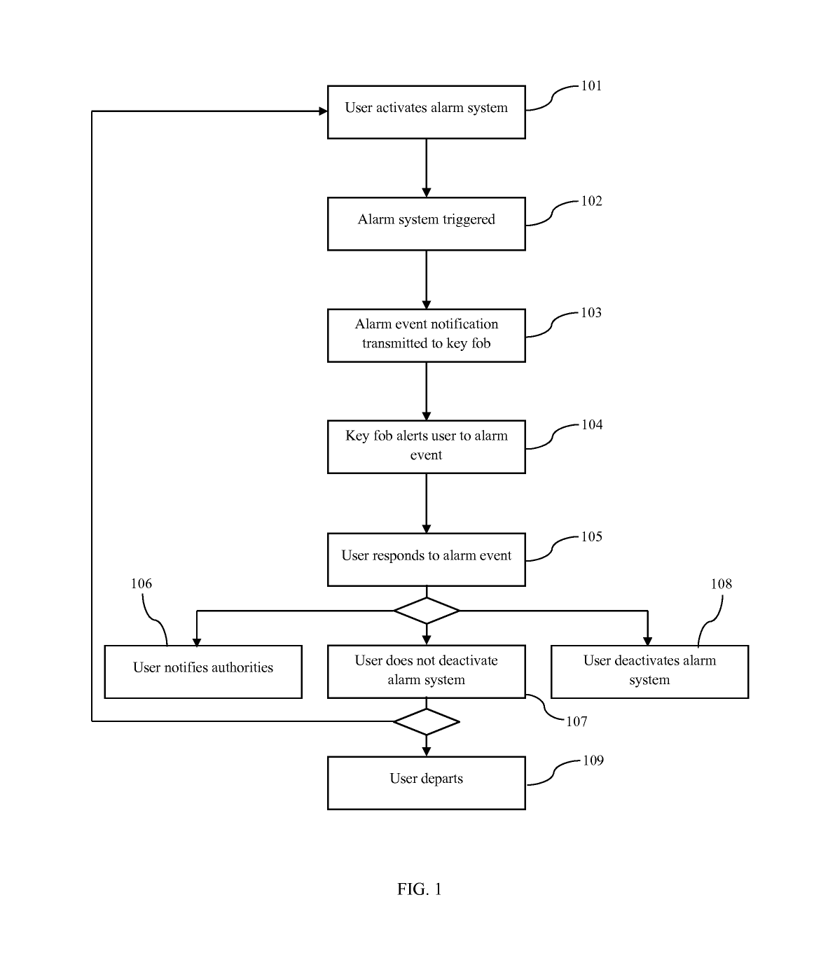

Referring now to FIG. 1, there is shown a flowchart for using an exemplary key fob with alarm notification as according to one embodiment of the present invention. A user may activate an alarm system (101) by pressing a lock or arm button on the key fob. Alternatively, the user may activate the alarm system (101) manually by pressing a door lock button in a vehicle or by using a program on a computer to activate the alarm system. Once the alarm system has been activated (101), the alarm system may subsequently become triggered (102) by a triggering event. Triggering events are commonly unauthorized intrusions into the vehicle, accidental contact with the exterior of the vehicle, or any other event that causes an alarm system to activate. Once the alarm system has been triggered (102), an alarm event notification may be transmitted from the vehicle to the user's key fob (103). Transmission of the alarm event notification (103) may occur wirelessly and may be transmitted directly to the key fob from the vehicle, or may be transferred indirectly through one or more electronic devices that relay the signal to the key fob. Direct transmission of the alarm event notifications (103) may provide only local or short-range communication between the vehicle and the alarm system. Some of the short-range technologies may include Short-Range Device (SRD) radio transmissions, Bluetooth® communications, or Digital Spread Spectrum (DSS) technology.

Vehicles with alarm systems may communicate with a user's key fob through long-distance communication technologies such as cellular telephone communications. A vehicle may have an embedded cellular telephone communication device that transmits an alarm event notification to a key fob when the alarm system is triggered (102). Alternatively, a vehicular alarm system may communicate with a user's key fob through computer-based communication technologies such as Wide Area Network (WAN) or Local Area Network (LAN) technologies. An alarm system could send signal from an onboard WAN or LAN device to a wireless router that relays the signal, either wirelessly, wired or any combination thereof, through a computer network such as an Ethernet to a user's key fob. Once the signal is received by the user's key fob, the key fob may notify the user of the alarm event.

After the user has been notified of an alarm event (104), the user may choose to respond to the alarm event (105). User response to the alarm event (104) may include visually inspecting the vehicle, requesting that another person visually inspect the vehicle, in the event that the user is in a remote location, using a remote viewing device such as a camera in a CCTV system to inspect the vehicle, checking the status vehicle via a computer program that is able to report the status of a vehicle, or contacting a monitoring service responsible for monitoring the status of a vehicle.

The user has a choice to make after responding to the alarm event (105). If an unauthorized activity has occurred or is occurring, the user may choose to notify authorities (106). Unauthorized events may include, but not be limited to, theft, vandalism, break-ins, damage, accidents, collisions, impact, or other illegal or legal activities that the user believes will best be handled by police or other authorities. In one exemplary embodiment of the invention, a user may respond to an alarm event (105) and discover that a vandal is in the process of spray-painting the side of the user's vehicle. The user may choose to contact the police (106) and inform them of the vandalism.

A user may choose not to deactivate a vehicle's alarm system (107) after responding to an alarm event (105). This choice may be made after a user responds to an alarm event (105), discovers that the alarm event was not a false alarm, but decides the authorities are not required and the vehicle's alarm system should remain armed. In one exemplary embodiment of the present invention, a user may respond to an alarm event (105) and discover that a neighborhood child accidently caused a basketball to contact the user's car. If no damage occurred, the user may choose to disregard the event and keep the vehicle's alarm system active (107).

A user may choose to deactivate a vehicle's alarm system (108) after responding to an alarm event (105). A user may discover that a false alarm has occurred after responding to an alarm event (105). Many factors may cause a vehicle's alarm system to produce a false alarm. Faulty wiring, ambient temperature changes, seismic events, and even transient sounds have been known to cause false alarms within vehicular alarm systems. A user may choose to deactivate a vehicle's alarm system (108) after responding to an alarm event (105) if the event was a false alarm. Alternatively, a user may choose to deactivate a vehicle's alarm system (108) even though an alarm event was not a false alarm. In a preferred embodiment of the present invention, another vehicle may collide with a user's vehicle thereby triggering the alarm system (102). The user may choose to deactivate the alarm system (108) to stop the noise of the alarm while investigating the damage to the user's vehicle.

In the event that a user has chosen to deactivate the alarm system (108), the user may then choose to reactivate the alarm system (101), or may choose to depart without reactivating the vehicle's alarm system (108). If the user departs (109), he or she may choose to do so by operating the vehicle, or by leaving the proximity of the vehicle on foot, or in another vehicle.

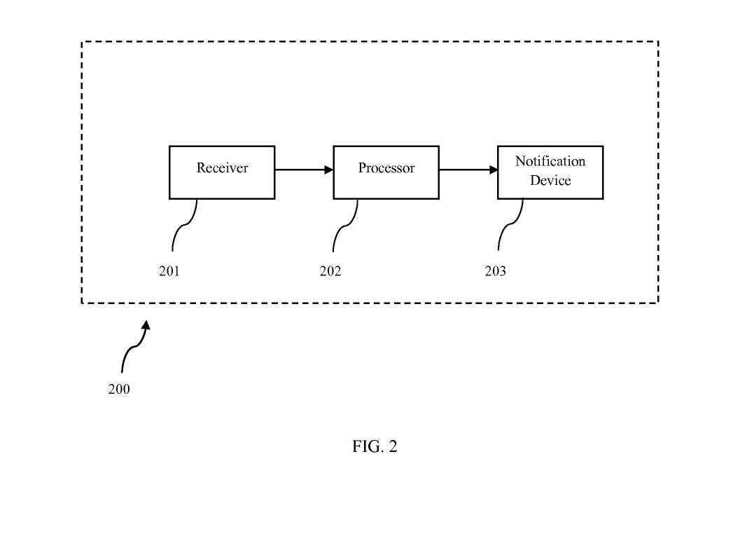

Referring now to FIG. 2, there is shown a schematic block diagram of an exemplary key fob with alarm notification (200) as according to one embodiment of the present invention. The key fob (200) may have a receiver (201) that receives signals transmitted from a vehicle's alarm system. The signals transmitted from a vehicle's alarm system may be sent through a cellular network. The key fob is not limited to receiving signals from a particular cellular protocol. Many competing cellular protocols such as 3G, GSM, LTE, EDGE, CDMA, WCDMA, exist today with new cellular protocols emerging frequently. The key fob's receiver (201) may be configured to receive any or all of the aforementioned cellular protocols, or new protocols as they are implemented.

In another preferred embodiment of the present invention, the key fob may receive alarm event notifications from a vehicle by way of communications sent through a local area network (LAN). LAN communications may be sent from a vehicle to a key fob's receiver (201) through Wi-Fi wireless communications. Wi-Fi is a popular technology that allows computer networks to exchange information over the air using radio waves. The key fob's receiver (201) and the vehicle's alarm system may be configured as computer devices on a Wi-Fi network for the purposes of communicating alarm events to the key fob. Although Wi-Fi is currently one of the most common protocols for wireless LAN communications, the present invention may be used with any future protocols developed for wireless communications between computers in a LAN.

In yet another preferred embodiment of the present invention, the key fob may receive alarm event notifications from a vehicle by way of communications sent through a wide area network (WAN). A WAN is a telecommunication network that covers broad areas such as entire communities, cities, or regions. This embodiment of the present invention may use a TCP/IP packet-based protocol across a single or multiple computer networks, such as the internet, to deliver alarm event communications to a key fob's receiver (201). WAN communications for purposes of the present invention may include wireless signals, wired signals, or any combination thereof to transmit alarm event information.

After receiving an alarm event notification at a key fob's receiver (201), the receiver may communicate an alarm event signal to a key fob's processor (202). The key fob's processor (202) may be a digital signal processor (DSP), microcontroller, microprocessor, host processor, or any other processing device capable of processing signals in a key fob with alarm event notification capabilities. The processor (202) may have onboard logic or a program that causes the processor to interpret signals received from the key fob receiver (201) and to generate messages that are sent to a key fob's notification device (203). The key fob's notification device may notify a user of an alarm event. Notification may occur by visual means, such as by way of a blinking light; by auditory means, such as by way of sound emitted through an onboard speaker; by tactile means, such as a vibrating device built in to the key fob; or by any combination of visual, auditory, or tactile means.

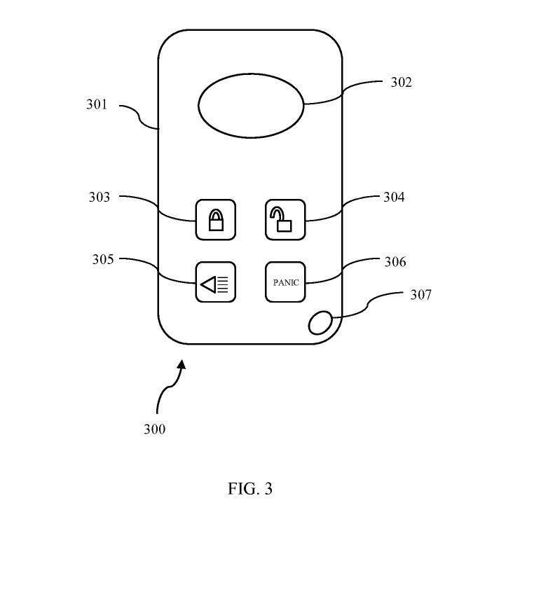

Referring now to FIG. 3, there is shown an exemplary key fob with a visual alarm notification feature (300) as according to one embodiment of the present invention. The key fob with a visual alarm notification feature (300) may have a key fob housing (301) that contains a visual notification feature (302). The visual notification feature (302) may be a light that notifies the user when a vehicle's alarm system has been triggered (FIG. 1, 102). The light may pulse, flash, change color, or remain steadily illuminated. The visual notification feature may also be a display device that displays information about the vehicle alarm system. The display device may display alphanumeric characters indicating which zone of a vehicle alarm system has been triggered, a visual depiction of the vehicle showing which portion of the vehicle is registering trouble, or any other information that may notify a user of an alarm event. The key fob housing (301) may also contain a plurality of buttons (303, 304, 305, 306) that control features commonly found on a vehicle with an alarm system. The plurality of buttons (303, 304, 305, 306) may consist of a button that locks or arms the alarm system of a vehicle (303), a button that unlocks or disarms the alarm system of a vehicle (304), a button that activates the headlights of a vehicle (305), or a button that sounds the alarm system of a vehicle (306). The key fob housing (301) may also contain a key ring cut out (307). The key ring cut out (307) may allow a user to affix the key fob with a visual alarm notification feature (300) on a key ring for easy use or transport.

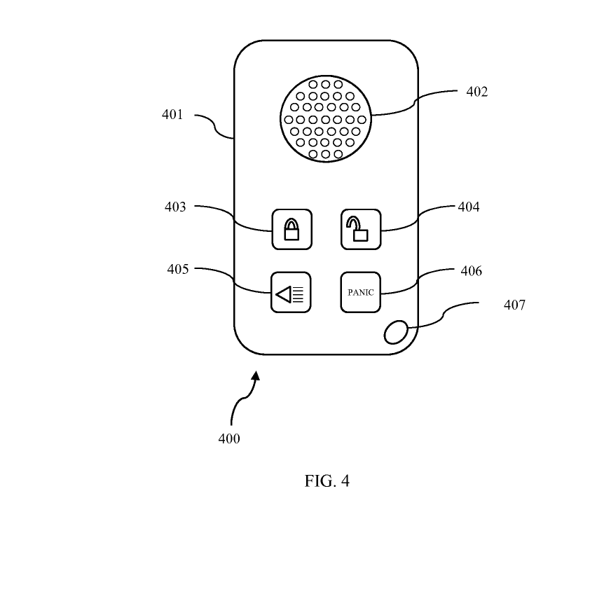

Referring now to FIG. 4, there is shown an exemplary key fob with an audible alarm notification feature (400) as according to one embodiment of the present invention. The key fob with an audible alarm notification feature (400) may have a key fob housing (401) that contains an audible notification feature (402). The audible notification feature (402) may be a speaker that emits sound to notify the user when a vehicle's alarm system has been triggered (FIG. 1, 102). The emitted sound may be a steady tone, pulse, or any other sound intended to notify a user of an alarm system event. The key fob housing (401) may also contain a plurality of buttons (403, 404, 405, 406) that control features commonly found on a vehicle with an alarm system. The plurality of buttons (403, 404, 405, 406) may consist of a button that locks or arms the alarm system of a vehicle (403), a button that unlocks or disarms the alarm system of a vehicle (404), a button that activates the headlights of a vehicle (405), or a button that sounds the alarm system of a vehicle (406). The key fob housing (401) may also contain a key ring cut out (407). The key ring cut out (407) may allow a user to affix the key fob with an audible alarm notification feature (400) on a key ring for easy use or transport.

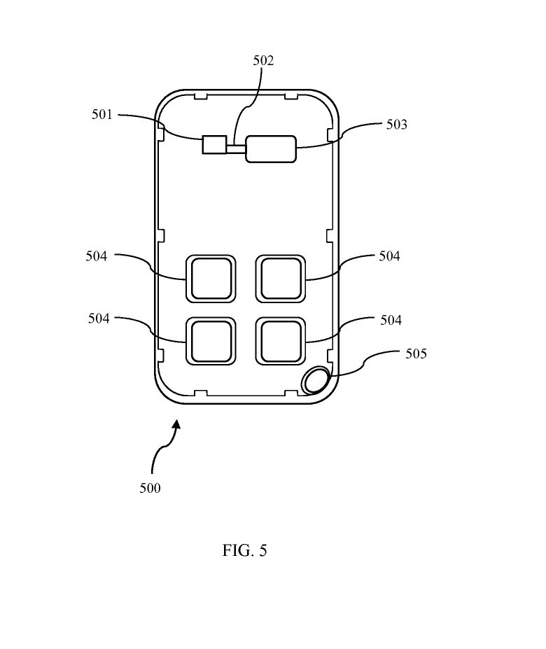

Referring now to FIG. 5, there is shown an interior view of an exemplary key fob with a vibrating alarm notification feature (500) as according to one embodiment of the present invention. The key fob with a vibrating alarm notification feature (500) may have a key fob housing (501) that contains a vibration device motor (503), a vibration device shaft (502), and a vibration weight (501). The vibration device motor (503) may be an electric motor that causes the vibration device shaft (502) to rotate at high speeds. The vibration weight (501) may be affixed to the end of the vibration device shaft (502) that is opposite from the vibration device motor (503). The vibration weight (501) may be affixed to the to the vibration device shaft (502) in a non-concentric manner so that when the vibration device shaft (502) rotates, the non-concentric orientation of the vibration weight (501) causes the key fob with a vibrating alarm notification feature (500) to vibrate. The key fob housing (501) may also contain a plurality of button receptacles (503, 504, 505, 506) that could contain buttons that control features commonly found on a vehicle with an alarm system. The plurality of button receptacles (503, 504, 505, 506) may house a button that locks or arms the alarm system of a vehicle, a button that unlocks or disarms the alarm system of a vehicle, a button that activates the headlights of a vehicle, or a button that sounds the alarm system of a vehicle. The key fob housing (501) may also contain a key ring cut out (507). The key ring cut out (507) may allow a user to affix the key fob with a vibrating alarm notification feature (500) on a key ring for easy use or transport.

An exemplary key fob may possess a visual alarm notification feature, an audible alarm notification feature, a vibrating alarm notification feature, or any combination thereof. Some users may prefer a key fob that possess an audible alarm notification feature and a vibrating alarm notification feature, but not a visual alarm notification feature, so that they may be notified of alarm events when the key fob is not immediately visible. The user may keep the key fob in their pocket where a visual alarm notification feature would not be of use.

It should be noted that the example software and/or firmware implementations described herein may be optionally stored on a tangible storage medium, such as: a magnetic medium (e.g., a disk or tape); a magneto-optical or optical medium such as a disk; or a solid state medium such as a memory card or other package that houses one or more read-only (non-volatile) memories, random access memories, or other re-writable (volatile) memories; or a signal containing computer instructions. A digital file attachment to e-mail or other self-contained information archive or set of archives is considered a distribution medium equivalent to a tangible storage medium. Accordingly, the example software and/or firmware described herein can be stored on a tangible storage medium or distribution medium such as those described above or equivalents and successor media.

To the extent the above specification describes example components and functions with reference to particular devices, standards and/or protocols, it is understood that the teachings of this disclosure are not limited to such devices, standards and/or protocols. Such systems are periodically superseded by faster or more efficient systems having the same general purpose. Accordingly, replacement devices, standards and/or protocols having the same general functions are equivalents which are intended to be included within the scope of the accompanying claims.

Although certain exemplary embodiments of a key fob with alarm notification have been described herein, the scope of coverage of this patent is not limited thereto. On the contrary, this patent covers all embodiments of a key fob with alarm notification fairly falling within the scope of the invention either literally or under the doctrine of equivalents.

With respect to the above description then, it is to be realized that the optimum configuration and relationships for the elements of the a key fob with alarm notification are deemed readily apparent and obvious to one skilled in the art, and all equivalent relationships to those illustrated in the images and described in the specification are intended to be encompassed by the present invention.

Therefore, the foregoing is considered as illustrative only of the principles of the key fob with alarm notification. Further, since numerous modifications and changes will readily occur to those skilled in the art, it is not desired to limit the center to the exact construction and operation shown and described, and accordingly, all suitable modifications and equivalents may be resorted to, falling within the scope of the a key fob with alarm notification. While the above description describes various embodiments of the present invention, it will be clear that the present invention may be otherwise easily adapted to satisfy any requirements of a key fob with alarm notification.

As various changes could be made in the above configuration or organization without departing from the scope of the invention, it is intended that all matter contained in the above description or shown in the accompanying images shall be interpreted as illustrative and not in a limiting sense.

What is claimed is:

1. An apparatus comprising:
a key fob housing that contains an alarm notification feature and a plurality of buttons, wherein the alarm notification feature notifies a user of an alarm event when a vehicular alarm system has been triggered.

2. The apparatus of claim 1, wherein the alarm notification feature is a visual alarm notification feature.

3. The apparatus of claim 1, wherein the alarm notification feature is an audible alarm notification feature.

4. The apparatus of claim 1, wherein the alarm notification feature is a vibrating alarm notification feature.

5. The apparatus of claim 1, wherein one of the pluralities of buttons arms the vehicular alarm system.

6. The apparatus of claim 1, wherein one of the plurality of buttons disarms the vehicular alarm system.

7. The apparatus of claim 1, wherein the key fob housing further contains a key ring cut out.

8. The apparatus of claim 2, wherein the visual alarm notification feature is a blinking light.

9. A system for notifying a user of a vehicular alarm event comprising:
a key fob with a key fob housing; a plurality of buttons contained within the key fob housing; and an alarm notification feature contained within the key fob housing that notifies a user when a vehicular alarm system has been triggered.

10. The system of claim 9, wherein the alarm notification feature is a visual alarm notification feature.

11. The system of claim 9, wherein the alarm notification feature is an audible notification feature.

12. The system of claim 9, wherein the alarm notification feature is a vibrating notification feature.

13. The system of claim 9, wherein one of the plurality of buttons arms the vehicular alarm system.

14. The system of claim 9, wherein one of the plurality of buttons disarms the vehicular alarm system.

15. A key fob comprising;
a receiver for receiving a signal transmitted from a vehicular alarm system, a processor for processing signals, and an alarm event notification device that notifies a user of an alarm event.

16. The key fob of claim 15, wherein the alarm event notification device is a visual alarm notification feature.

17. The key fob of claim 15, wherein the alarm event notification device is an audible alarm notification feature.

18. The key fob of claim 15, wherein the alarm event notification device further comprises a vibration motor attached to a vibration weight.

19. The key fob of claim 15, wherein the receiver, processor, and alarm event notification device are contained within a key fob housing.

20. The key fob of claim 19, wherein the key fob housing further contains a plurality of buttons that control features of a vehicular alarm system.
